(19) United States
(12) Patent Application Publication
(10) Pub. No.: US 2014/0250208 A1
(43) Pub. Date: Sep. 4, 2014

(54) GROUPING PERSONAL PLAYLISTS INTO BUDDY LIST USED TO MODIFY A MEDIA STREAM

(71) Applicants: David Paul Billmaier, Woodinville, WA (US); Jason Christopher Hall, Seattle, WA (US); Alexander Charles Barclay, Seattle, WA (US); John Max Kellum, Seattle, WA (US); Henry Hideyuki Yamamoto, Issaquah, WA (US)

(72) Inventors: David Paul Billmaier, Woodinville, WA (US); Jason Christopher Hall, Seattle, WA (US); Alexander Charles Barclay, Seattle, WA (US); John Max Kellum, Seattle, WA (US); Henry Hideyuki Yamamoto, Issaquah, WA (US)

(21) Appl. No.: 14/351,877

(22) PCT Filed: Oct. 27, 2011
(86) PCT No.: PCT/US2011/058162

§ 371 Date: Apr. 15, 2014

(51) Int. Cl. H04L 29/06

(52) U.S. Cl. CPC H04L 65/60
USPC 709/217

(57) ABSTRACT

Illustrated is a system and method comprising a plurality of personal playlists, grouped to form a buddy list, the buddy list disposed on a remote storage device. The system and method further comprises logic, which when executed at the remote storage device that streams media content to at least one user device based upon a streaming media playlist. Additionally, the system and method is executed to provide access to the streaming media playlist to the at least one user device. Moreover, the system and method is executed to permit modification of the streaming media playlist by the at least one user device.

### BACKGROUND

Recommender systems work from a specific type of information filtering system technique that attempts to recommend information items (e.g., movies, TV program/show/episode, video on demand, music, books, news, images, web pages, scientific literature such as research papers etc.) or social elements (e.g., people, events or groups) that are likely to be of interest to the user. These recommendations may be based upon explicit or implicit forms of data collection.

The information items may be stored on a server that exists as part of a cloud based computing system. The storage of these items may be metaphorically described as a “cloud locker” or “digital locker”, whereby the information items owned or licensed to the user are stored remotely on a server such that they are accessible by any device with network connectivity. These information items (referenced herein as “media”) may be streamed across the network to one or more of these devices with network connectively.

### BRIEF DESCRIPTION OF THE DRAWINGS

Some embodiments of the invention are described, by way of example, with respect to the following figures:

FIG. 1 is a diagram of a system, according to an example embodiment, used to allow a user to view and participate in the playlists of other users while media is streamed from a media server.

FIG. 2 is a diagram of a system, according to an example embodiment, used to allow a user to view and generate a buddy list based upon recommendations provided by one or more users.

FIG. 3 is a diagram of a system, according to an example embodiment, illustrating the play lists generated while media is streamed from a media server.

FIG. 4 is a diagram of a system, according to an example embodiment, illustrating the generation of a buddy list based upon recommendations provided by one or more users.

FIG. 5 is a block diagram of a system, according to an example embodiment, used to allow a user to view and participate in the playlists of other users while media is streamed from a media server.

FIG. 6 is a flow chart illustrating a method, according to an example embodiment, to allow a user to view and participate in the playlists of other users while media is streamed from a media server.

FIG. 7 is a block diagram of a system, according to an example embodiment, used to allow a user to view and participate in the playlists of other users while media is streamed from a media server.

FIG. 8 is a flow chart illustrating a method, according to an example embodiment, executed to allow a user to view and participate in the playlists of other users while media is streamed from a media server.

FIG. 9 is a flow chart illustrating a method to execute operation, according to an example embodiment, that is used to apply recommendations to the streaming media playlist, the recommendations made by any user grouped within the buddy list.

FIG. 10 is a flow chart illustrating a method, according to an example embodiment that, when executed, makes media available to the playlists of other users and the buffers associated therewith contingent upon an agreement to pay an acquisition cost associated with the media.

FIG. 11 shows a diagrammatic representation of a machine in the example form of a computer system that executes a set of instructions to perform any one or more of the methodologies discussed herein.

### DETAILED DESCRIPTION

Illustrated is a media-delivery system and method to allow a user to view and participate in the playlists of other users while media is streamed from a media server. Through using this system and method, real-time updates to a user playlist may be made by another user while the playlist is being used to identify media for streaming. Specifically, updates may be made simultaneously with the streaming of the media identified in the playlist. As used herein, simultaneously means happening, existing, or done at the same time. Participating in the playlist of other users includes the recommendation of media by one user to another user through the use of one or more communications technologies including instant messaging, email, a Short Message Service (SMS), a Multi-media Messaging Service (MMS), a Really Simple Syndication (RSS) service, or some other suitable communication technology. In some example embodiments, a control plane protocol is used to provide a recommendation. Media, as used herein, includes audio, video, and audio-video files formatted using an appropriate file format such as a Moving Pictures Experts Group (MPEG) format, an Advanced Audio Coding (AAC) format, or some other suitable format. As used herein, media and media content are synonymous. Media may be user owned media content, user un-owned media content, or a mixture of user owned and user un-owned media content. User owned means licensed or otherwise having legal title to the media. User on-owned means not licensed or having legal title to the media.

In some example embodiments, a media delivery system is illustrated that includes plurality of users, each user associated with a personal playlist, grouped to form a buddy list, the buddy list disposed on a remote storage device such as a media server. A personal playlist, as used herein, is a list of media specific to a particular user. A buddy list, as used herein, is an aggregation of one or more media at least one of which is identified in a personal playlist. Further, the buddy list may include a playlist of contributions from a plurality of persons. The media delivery system may also include a remote storage device with logic encoded thereon, and when executed streams media content to at least one user device based upon a streaming media playlist. Further, the logic may be executed to provide access to the streaming media playlist to the at least one user device. Additionally, the logic may be executed to permit modification of the streaming media playlist by the at least one user device. A user device, as used herein, may be a cell phone, tablet/slate computer, laptop computer, Personal Digital Assistant (PDA). Smartphone, or other suitable computing device. The streaming of media, as used herein, may use anyone of a number of protocols and services including a Real Time Streaming Protocol (RTSP), WINDOWS MEDIA SERVICES™ (WMS), QUICKTIME STREAMING SERVER™, or some other suitable protocol or service. In come example embodiments, a data plane protocol is used to provide a recommendation.

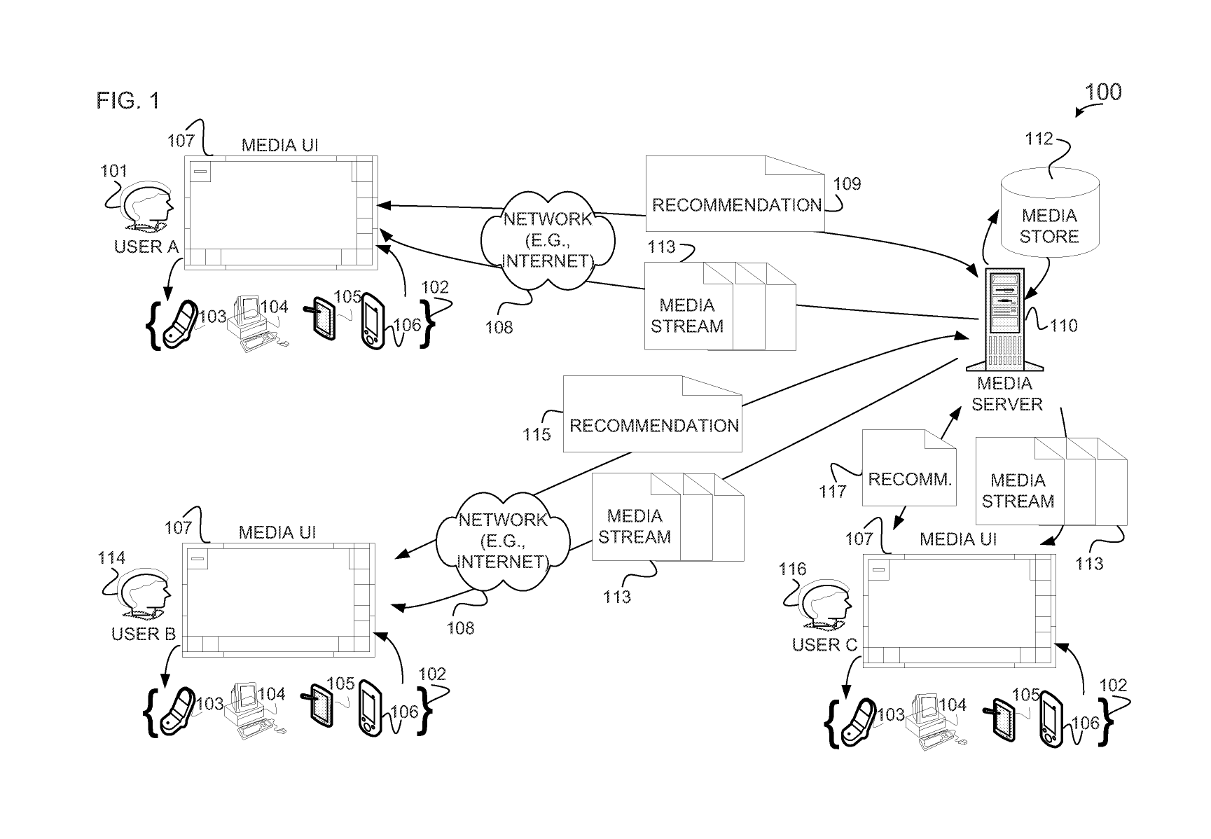

FIG. 1 is a diagram of an example system 100 used to allow a user to view and participate in the playlists of other users while media is streamed from a media server. Shown is a user A 101 who utilizes any one of the number of user devices (collectively referenced at 102) including a cell phone 103, personal computer 104, tablet/slate computer 105, or Smartphone 106 to generate a recommendation 109. In particular, the user A 101 uses a media user interface (UI) 107 to make recommendations for, for example, a buddy list. These recommendations are transmitted using one of the above referenced communication technologies. The media UI 107 may be generated using a web browser (i.e., an HTML interpreter), or created as part of a software application graphical user interface. As illustrated, a recommendation 109 is transmitted across a network 108 by one of the user devices to the media server 110. This media server 110 is also referenced herein as a remote storage device. Operatively coupled to the media server 110 is a media store 112. This media store 112 may be a “cloud locker” or “digital locker”. Operatively coupled, as used herein, is a logical or physical connection. Also shown is a media stream 113 that is transmitted from the media server 110 across the network 108 to one of the user devices. Further shown is a user B 114 who uses one of the uses devices to generate a recommendation 115 that is transmitted across the network 108 to the media server 110. The media stream 113 may be transmitted simultaneously with the transmission of the recommendation 115. Additionally shown is a user C 116 who uses one of the user devices to generate the recommendation 117 and to transmit this recommendation 117 across the network 108 using one of the user devices to the media serve 110. The media stream 113 may be simultaneously transmitted to the user device being utilized by the user C 116. As stated above, the recommendations 109, 115, and 117 may be transmitted to the media server 110 simultaneously with the delivery of a media stream 113 by the media server 110 to one or more of the user devices. In some example embodiments, the recommendations 109, 115, and 117 advocate the updating of a user playlist (e.g., the play list associated with the user A 101) using a portion of another user's play (e.g., the play list associated with the user B 114). This portion may be a single song, video clip or other suitable media.

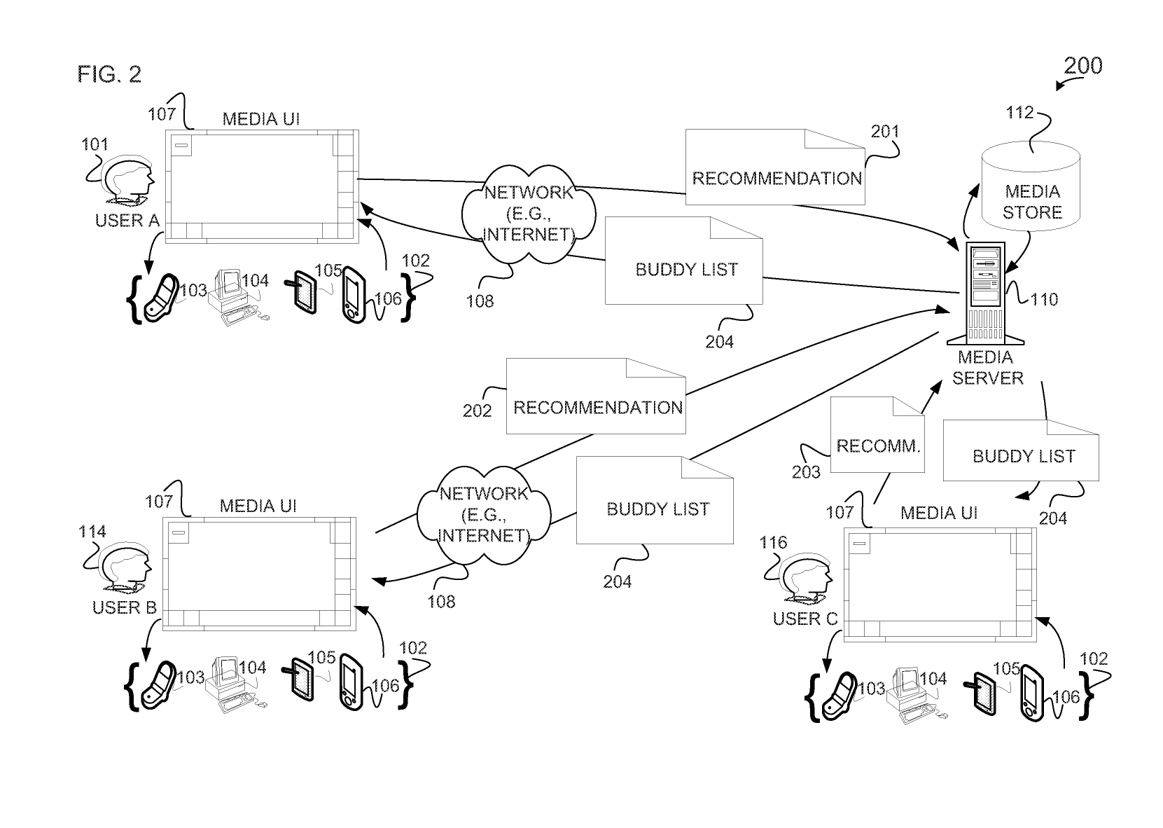

FIG. 2 is a diagram of an example system 200 used to allow a user to view and generate a buddy list based upon recommendations provided by one or more users. Shown is a recommendation 201 generated by the user A 101 using the media UI 107 created by a user device. Also shown is a recommendation 202 generated by the user B 114. Also shown is a recommendation 203 generated by the user C 116. These recommendations 201-203 are transmitted across the network 108 and received at the media server 110. The media server 110 combines or aggregates at least a portion of these recommendations 201-203 into a buddy list 204. The buddy list 204 is distributed to the user 101, 114 and 116, or any other user with the appropriate privileged for viewing the buddy list 204. Appropriate privileges include read, and write privileges, an also the privileged to access, play, perform use or otherwise interact with the media described by the buddy list. In some example embodiments, the buddy list 204 is a formatted as a character delimited flat file, an eXtensible Markup Language (XML) file, a Hyper Text Markup Language (HTML) file, or some other suitably formatted file. Further, the buddy list 204 may include links to media or other suitable ways to access media.

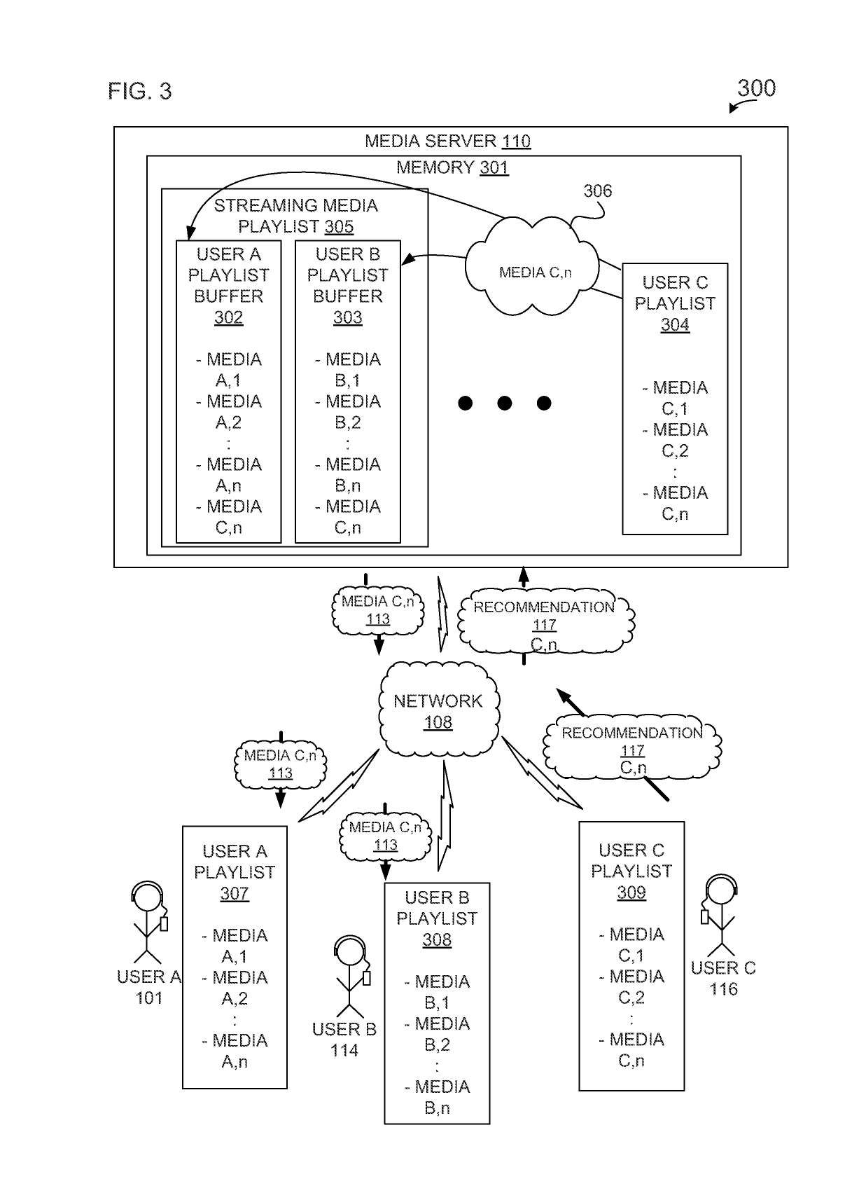

FIG. 3 is a diagram of an example system 300 illustrating the play lists generated while media is streamed from a media server. Shown is a media server 110 and memory 301 associated with the media server 110. Residing on the memory 301 is a user C playlist 304 (i.e., a personal play list). While the user C playlist 304 is shown, playlists for the user A and user B may also reside on this memory 301. In some example embodiments, the user C 116 makes a recommendation 117 that is transmitted to the media server 110. The recommendation 117 identifies media in the user C playlist 304 that is to be provided to, or otherwise made available to the playlists of other users (e.g., the user A 101 and the user B 114). Where the recommendation 117 is received at the media server 110, the identified media (e.g., “Media C, n”) is made available, as referenced at 306, to the playlists of the other users and the playlist buffers 302 and 303 associated with these other users. Made available, as user herein, includes providing a memory pointer or referent to the identified media in the user C playlist 304, copying the identified media into the buffer 302 and 303, or making it available via some other suitable way. As will be discussed in more detail below, 306 may be an operation or method executed by the media server 110. In some example embodiments, an acquisition cost for un-owned media content will be charged to users A and B for a license or other legal right to acquire the un-owned media content (i.e., media). The identified media is distributed to the user A 101 and user B 114 via the media stream 113. The user A 101 and user B 114 may access or use the identified media via a user device. Distributed, as used herein, includes broadcasting, unicasting, or some other suitable form a distribution.

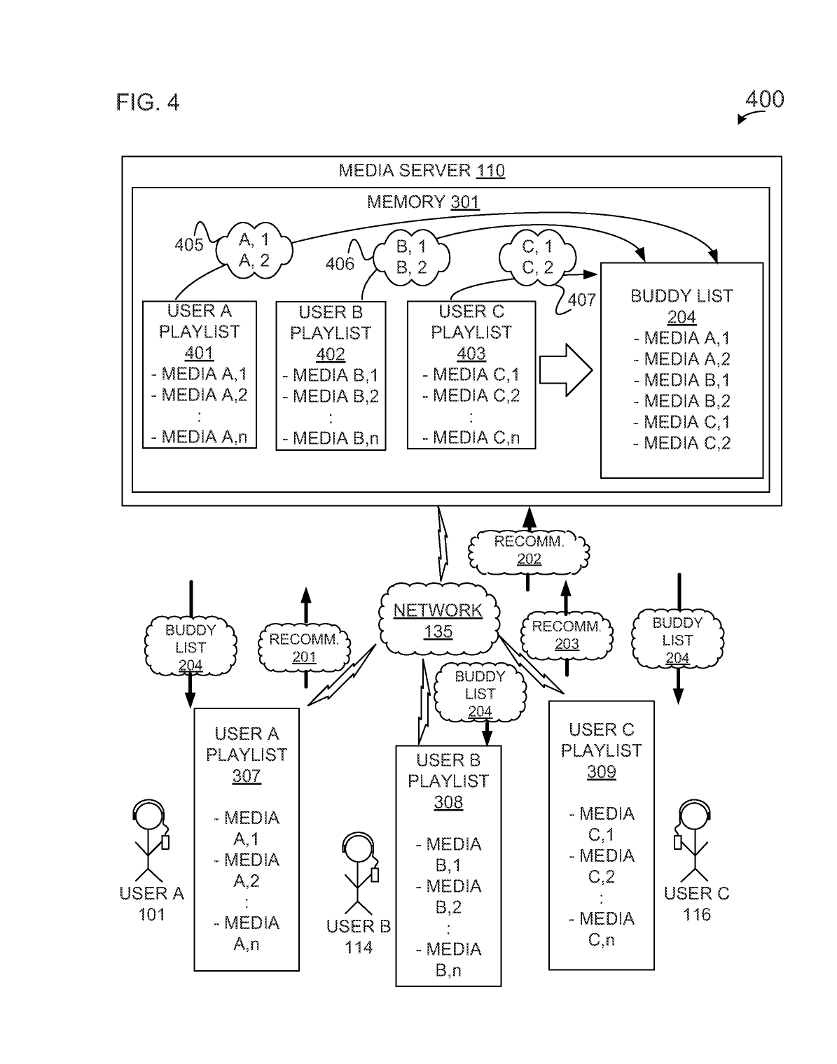

FIG. 4 is a diagram of an example system 400 illustrating the generation of a buddy list based upon recommendations provided by one or more users. Shown is a user A playlist 401, a user B playlist 402, and user C playlist 403. These playlists are personal playlists. As referenced at 405-407, media from these playlists may be identified via the recommendations 201-204 respectively and stored as part of the buddy list 204. Once identified the media may be made available to those users with access to the buddy list 204. The media may be identified via pointer or referent to the identified media. Example identified media is referenced at 405 (“A, 1” “A, 2”), 406 (“B, 1” “B, 2”), and 407 (“C, 1”C, 2”). Additionally, the media may be identified by the copying of the identified media to the buddy list 204. The buddy list 204 may be distributed to each of the user A 101, user B 114 and user C 116. The buddy list 204 may be incorporated into the one or more of the user A playlist 307, user B playlist 308, or user C playlist 309. In the alternative, the buddy list 204 may be maintained as a separate playlist.

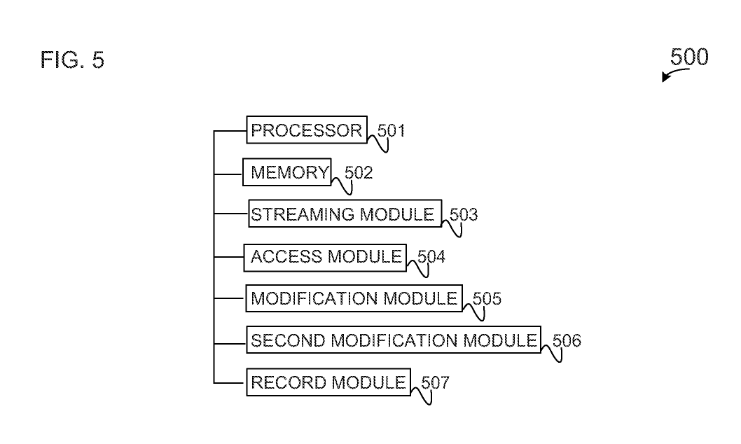

FIG. 5 is a block diagram of an example system 500 used to allow a user to view and participate in the playlists of other users while media is streamed from a media server. The various blocks shown herein may be implemented in software, hardware, or firmware. The system 100 is an example of the system 500. These blocks may be operatively connected, where operatively connected includes a physical or logical connection. Shown is a processor 501 operatively connected to a memory 502, both of which reside on a remote storage device such as the media server 110. Residing on the memory 502 is a plurality of personal playlists, grouped to form a buddy list, the buddy list disposed on a remote storage device as part of the memory 502. Logic resides upon this remote storage device and is executed by the process 501 to streams media content to at least one user device based upon a streaming media playlist. The logic to streams media content to at least one user device based upon a streaming media playlist may be executed by a streaming module 503 operatively connected to the processor 501. Additionally, logic residing on an access module 504 operatively coupled to the processor 501 may be executed to access to the streaming media playlists to the at least one user device. Moreover, logic residing on a modification module 505 operatively coupled to the processor 501 may be executed so permits modification of the streaming media playlist by the at least one user device. The logic may be executed by the processor 501 and/or the modules 503-505. In some example embodiments, the media content comprises at least one of: user owned media content, user un-owned media content, or a mixture of user owned and user un-owned media content. A second modification module 506 operatively connected to the processor 501 may be executed to modify at least one of the plurality of personal playlist through an addition of un-owned media content. A record module 507 operatively connected to the processor 501 may be executed to record a transaction that reflects an acquisition cost for the un-owned media content. The transaction, as used herein, may be a purchase transaction reflecting the monetary cost of purchasing or otherwise acquiring the media. In some example embodiments, acquisition cost of the un-owned media content is based at least in part on a number of users who acquire the un-owned media content. In some example embodiments, the buddy list is based upon a parameter comprising at least one of the following: a geographic location of a plurality of user devices, a biometric parameter associated with the plurality of user devices, a selected media preference criterion selected by the plurality of user devices; or a selected personal interest criterion selected by the plurality of user devices. In some example embodiments, the modification of the streaming media playlist by the at least one user device occurs simultaneously with the streaming of media content to at least one user device. Additionally, in some example embodiments, the streaming media playlist is uniquely generated for each of the user devices; each personal playlist includes any modifications to the personal playlist provided by the remaining user devices. The streaming media playlist may comprise the buddy list; the buddy list includes contributions from each personal playlist along with simultaneous updates to the buddy list made during the streaming of media identified in the buddy list.

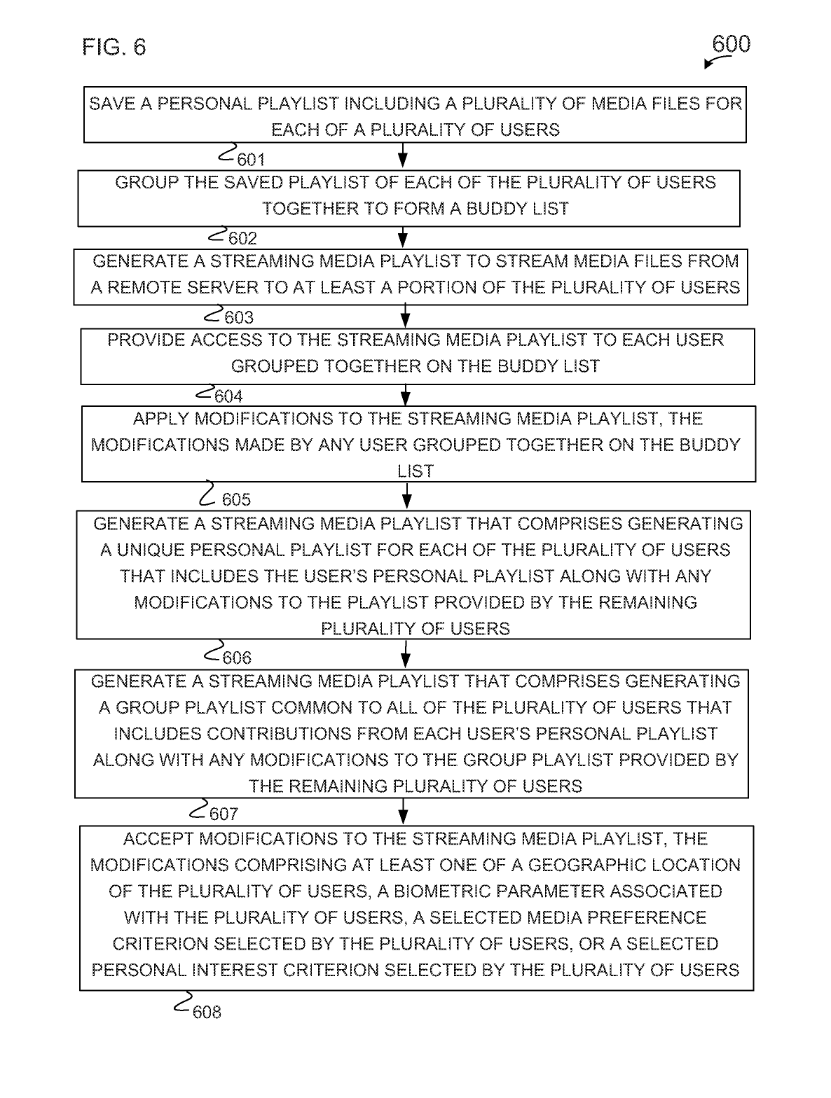

FIG. 6 is a flow chart illustrating an example method 600 to allow a user to view and participate in the playlists of other users while media is streamed from a media server. The method 600, and operations 601-608 included therein, may be executed on the media server 110. Operation 601 is executed to save a personal playlist including a plurality of media files for each of a plurality of users. Operation 602 is executed to group the saved playlist of each of the plurality of users together to form a buddy list. Operation 603 is executed to generate a streaming media playlist to stream media files from a remote server to at least a portion of the plurality of users. Operation 604 is executed to provide access so the streaming media playlist to each user grouped together on the buddy list. Operation 605 is executed to apply modifications to the streaming media playlist, the modifications made by any user grouped together on the baddy list. Operation 606 is executed to generate a streaming media playlist that comprises generating a unique personal playlist for each of the plurality of users that includes the user's personal playlist along with any modifications to the playlist provided by the remaining plurality of users. Operation 607 is executed us generate a streaming media play list that comprises generating a group playlist common to all of the plurality of users, that includes contributions from each user's personal playlist along with any modifications to the group playlist provided by the remaining plurality of users. Operation 608 is executed to accept modifications to the streaming media playlist, the modifications comprising at least one of: a geographic location of the plurality of users, a biometric parameter associated with the plurality of users, a selected media preference criterion selected by the plurality of users, or a selected personal interest criterion selected by the plurality of users.

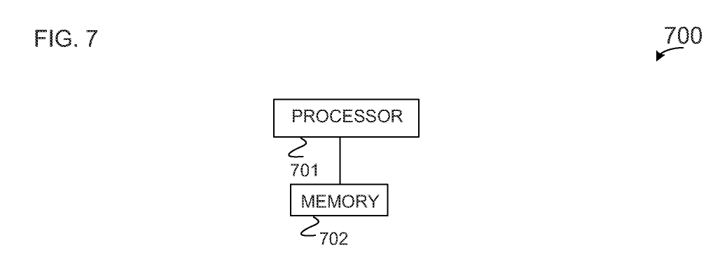

FIG. 7 is a block diagram of an example system 700 used to allow a user to view and participate in the playlists of other users while media is streamed from a media server. The system 100 is an example of the system 700. Shown is a processor 701 operatively connected to a memory 702. The processor 701 and memory 702 may reside on the media server 110. The memory 702 is in communication with the central processor 701, the memory 702 including a computer-readable medium having instructions stored thereon for causing a suitably programmed computer to execute a method comprising saving a personal playlist including a plurality of media files for each of a plurality of users. In some example embodiments, the instructions when executed may group the saved playlist of each of the plurality of users together to form a buddy list. In some example embodiments, the instructions when executed may generate a streaming media playlist to stream media files from a remote server to at least a portion of the plurality of users. In some example embodiments, the instructions when executed may provide access to the streaming media playlist to each user grouped together on the buddy list. Additionally, the instructions, when executed, may apply modifications to the streaming media playlist simultaneously with the providing of access to the streaming media playlist, the modifications made by any user grouped together on the buddy list. In some example embodiments, the instructions may be executed to generate a unique personal playlist for each of the plurality of users that includes the user's personal playlist along with any modifications to the playlist provided by the remaining plurality of users. Further, the instructions may be executed to generate the group playlist common to all of the plurality of users that includes contributions from each user's personal playlist along with any modifications to the group playlist provided by the remaining plurality of users.

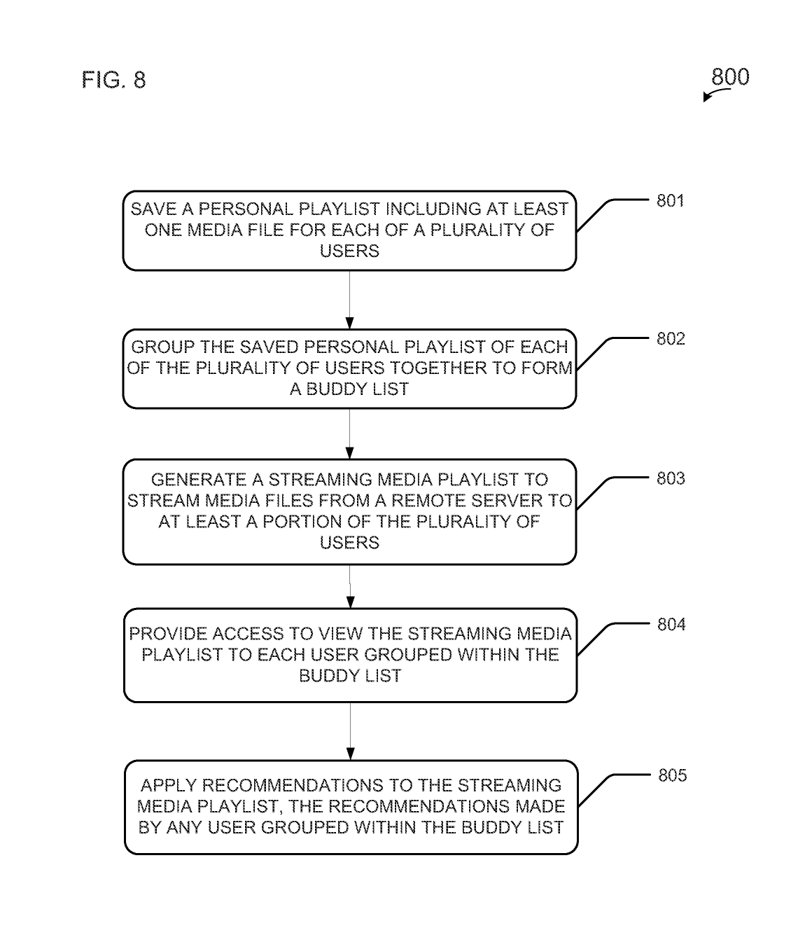

FIG. 8 is a flow chart illustrating an example method 800 executed to allow a user to view and participate in the playlists of other users while media is streamed from a media server. This method 800 may be executed by the media server 110, or some other suitable device. Shown is an operation 801 that is executed to save a personal playlist including at least one media file for each of a plurality of users. Example personal playlists include the user A playlist 401, a user B playlist 402, and a user C playlist 403. Operation 802 is executed to group the saved personal playlists of each of a plurality of users together to form a buddy list. FIG. 4 illustrates this grouping to form a buddy list such as the buddy list 204. Operation 803 is executed to generate a streaming media playlist to stream media files from a remote server to at least a portion of the plurality of users. Media stream 113 is an example of the stream of media files. Operation 804 is executed to provide access to view the streaming media playlist to each user grouped within the buddy list. Operation 805 is executed to apply recommendations to the streaming media playlist, the recommendations made by any user grouped within the buddy list. Recommendations may be the recommendations 201-203.

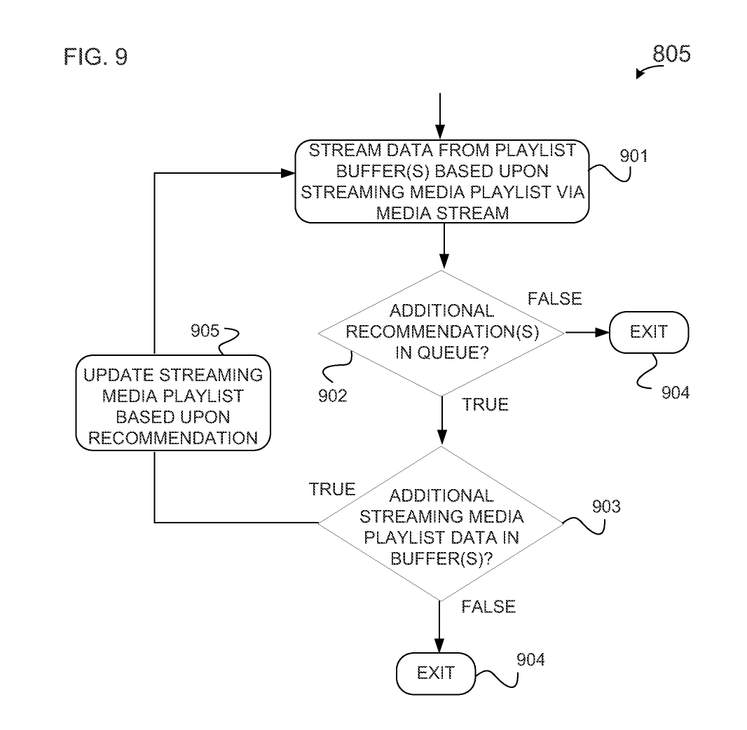

FIG. 9 is a flow chart illustrating an example method to execute operation 805 that is used to apply recommendations to the streaming media playlist, the recommendations made by any user grouped within the buddy list. Shown is an operation 901 that is executed to stream data from a playlist buffer based upon a streaming media playlist, the streaming via a media stream. A decision operation 902 is executed to determine if there are additional recommendations in the queue or other suitable data structure. In cases where decision operation 902 evaluates to “false”, a termination operation 904 is executed. In cases where decision operation 902 evaluates to “true”, a further decision operation 903 is executed. Decision operation 903 is used to determine whether there is additional streaming media playlist data in buffers. In cases where decision operation 903 evaluates to “false”, the termination condition 904 is executed. In cases where decision operation 903 evaluates to “true”, an operation 905 is executed. Operation 905 is executed to update the streaming media playlist based upon a recommendation.

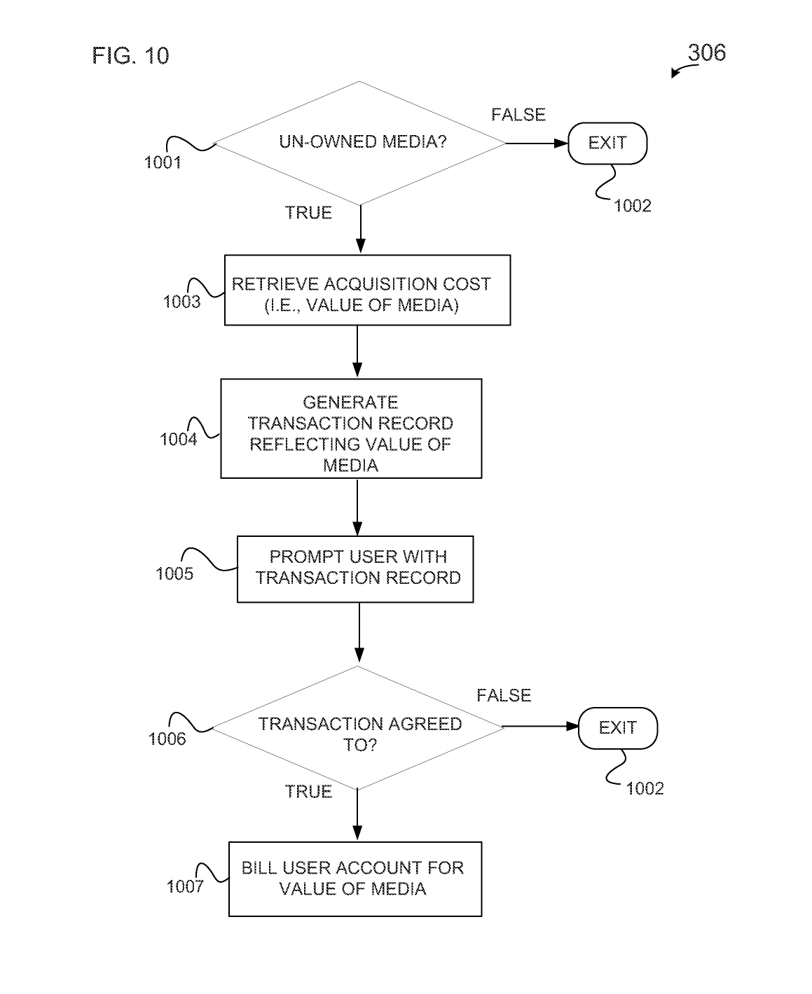

FIG. 10 is a flow chart illustrating an example method 306 that, when executed, makes media available to the playlists of other users and the buffers associated therewith contingent upon an agreement to pay an acquisition cost associated with the media. In some example embodiments, the charging of the acquisition costs associated with the method 306 is optional. Shown is a decision operation 1001 that is executed to determine whether the media to be transferred is currently un-owned by the user receiving the media. This determination may be made by comparing the media in the user A playlist buffer 302 and/or the user B playlist buffer 303 to the identified media (e.g., “Media C, n”) being made available. If decision operation 1001 evaluates to “false”, a termination operation 1002 is executed. If decision operation 1001 evaluates to “true”, an operation 1003 is executed. Operation 1003 is executed to retrieve the acquisition cost from a database (e.g., media store 112) that includes the costs for each media. Cost may be in some denomination of legal currency, over even virtual currency. Operation 1004 is executed to generate a transaction record reflecting the value of media. An invoice reflecting the purchase of the media is an example of a transaction record. Operation 1005 is executed to prompt a user with the transaction record. Prompting may be in the form of sending an email, SMS message, MMS message, of generating a prompt that is part of the media UI 107. Decision operation 1006 is executed to determine whether a user agreed to a transaction. Agreement may be denoted by, for example, the user A 101 or user B 114 selecting a UI button or widget appearing on the media UI 107 showing agreement to the transaction or acquisition cost. In cases where decision operation 1006 evaluates to “false”, the termination operation 1002 is executed. In cases where the decision operation 1006 evaluates to “true” an operation 1007 is executed. Operation 1007 is executed to bill, invoice or debt a user account for the value of the media (i.e., the acquisition cost). A user account may be a credit card account, or debt card account.

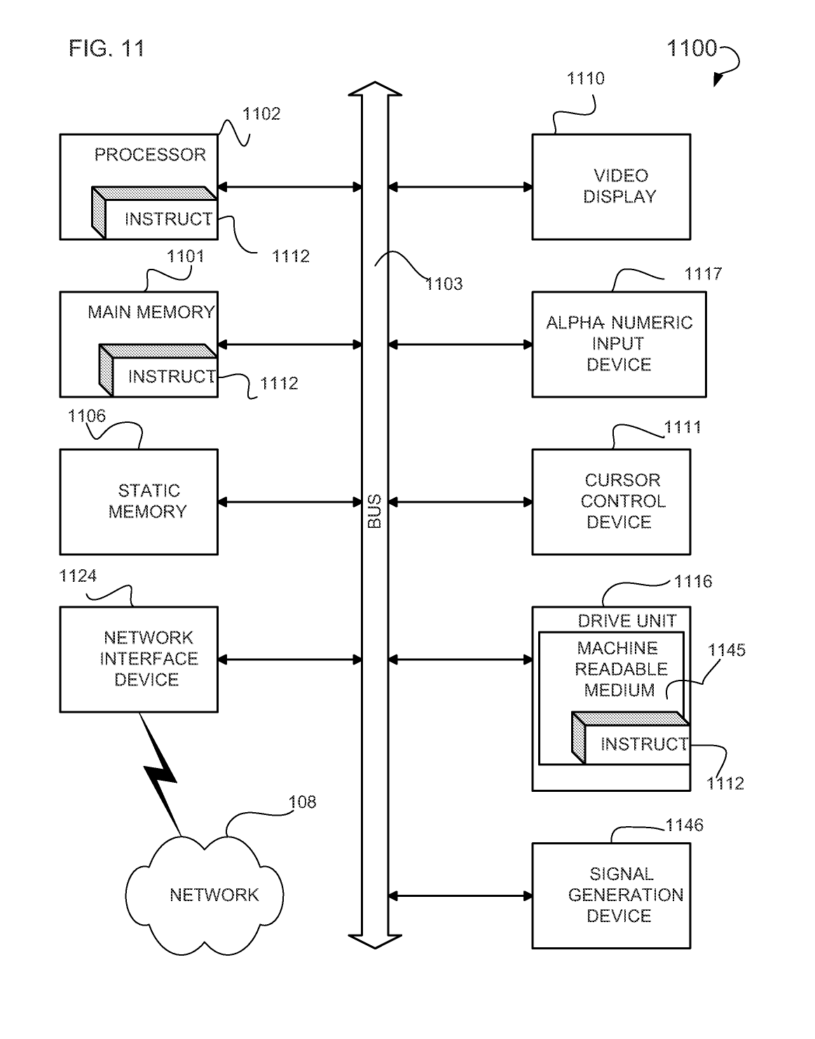

FIG. 11 shows a diagrammatic representation of a machine in the example form of a computer system 1100 that executes a set of instructions to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a PC, a table PC, a Set-Top Box (STB), a PDA, a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The example computer system 1100 includes a processor 1102 (e.g., a Central Processing Unit (CPU), a Graphics Processing Unit (GPU) or both), a main memory 1101, and a static memory 1106, which communicate with each other via a bus 1103. The computer system 1100 may further include a video display unit 1110 (e.g., a Liquid Crystal Display (LCD) or a Cathode Ray Tube (CRT)). The computer system 1100 also includes an alphanumeric input device 1117 (e.g., a keyboard), a User Interface (UI) cursor controller 1111 (e.g., a mouse), a disk drive unit 1116, a signal generation device 1146 (e.g., a speaker) and a network interface device (e.g., a transmitter) 1124.

The drive unit 1116 includes a machine-readable medium 1145 on which is stored one or more sets of instructions and data structures (e.g., software) embodying or used by any one or more of the methodologies or functions illustrated herein. The software may also reside, completely or at least partially, within the main memory 1101 and/or within the processor 1102 during execution thereof by the computer system 1100, the main memory 1101 and the processor 1102 also constituting machine-readable media 1145.

The instructions 1112 may further be transmitted or received over the network 118 via the network interface device 1124 using any one of a number of well-known transfer protocols (e.g., HTTP, Session Initiation Protocol (SP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, optical and/or magnetic mediums.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the “true” spirit and scope of the invention.

What is claimed is:

1. A media delivery system, comprising:
a plurality of personal playlists, grouped to form a buddy list, the buddy list disposed on a remote storage device; and
logic, which when executed at the remote storage device;
streams media content to at least one user device based upon a streaming media playlist;
provides access to the streaming media playlist to the at least one user device; and
permits modification of the streaming media playlist by the at least one user device.

2. The system of claim 1, wherein the media content comprises at least one of: user owned media content, user un-owned media content, or a mixture of user owned and user un-owned media content.

3. The system of claim 1, further comprising logic, which when executed at the remote storage device;
modifies at least one of the plurality of personal playlist through an addition of un-owned media content; and
records a transaction that reflects an acquisition cost for the un-owned media content.

4. The system of claim 3, wherein the acquisition cost of the on-owned media content is based at least in part on a number of users who acquire the un-owned media content.

5. The system of claim 1, wherein the buddy list is based upon a parameter comprising at least one of the following: a goegraphic location of a plurality of user devices, a biometric parameter associated with the plurality of user devices, a selected media preference criterion selected by the plurality of user devices, or a selected personal interest criterion selected by the plurality of user devices.

6. The system of claim 1, wherein the modification of the streaming media playlist by the at least one user device occurs simultaneously with the streaming of media content to at least one user device.

7. The system of claim 1, wherein the streaming media playlist is uniquely generated for each of the user devices, each personal playlist includes any modifications to the personal playlist provided by the remaining user devices.

8. The system of claim 1, wherein the streaming media playlist comprises the buddy list, the buddy list includes contributions from each personal playlist along with simultaneous updates to the buddy list made during the streaming of media identified in the buddy list.

9. A media delivery method, comprising:
saving a personal playlist including a plurality of media files for each of a plurality of users;
grouping the saved playlist of each of the plurality of users together to form a buddy list;
generating a streaming media playlist to stream media files from a remote server to at least a portion of the plurality of risers;
providing access to the streaming media playlist to each user grouped together on the buddy list; and
applying modifications to the streaming media playlist, the modifications made by any user grouped together on the buddy list.

10. The method of claim 9, wherein generating a steaming media playlist comprises:
generating a unique personal playlist for each of the plurality of users that includes the user's personal playlist along with any modifications to the playlist provided by the remaining plurality of users.

11. The method of claim 9, wherein generating a streaming media playlist comprises generating a group playlist common to all of the plurality of users that includes contributions from each user's personal playlist along with any modifications to the group playlist provided by the remaining plurality of users.

12. The method of claim 9, wherein accommodating modifications to the streaming media playlist comprises accepting modifications to the streaming media playlist, the modifications comprising at least one of: a geographic location of the plurality of users, a biometric parameter associated with the plurality of users; a selected media preference criterion selected by the plurality of users; or a selected personal interest criterion selected by the plurality of users.

13. A non-transitory computer-readable medium having instruction stored thereon for causing a suitably programmed computer to execute a method comprising:
saving a personal playlist including a plurality of media files for each of a plurality of users;
grouping the saved playlist of each of the plurality of users together to form a buddy list;
generating a streaming media playlist to stream media files from a remote server to at least a portion of the plurality of users;
applying modifications to the streaming media playlist simultaneously with the providing of access to the streaming media playlist, the modifications made by any user grouped together on the buddy list.

14. The non-transitory computer readable media of claim 13, further comprising the non-transitory computer-readable medium having instructions stored thereon for causing the suitably programmed computer to execute a method comprising generating a unique personal playlist for each of the plurality of users that includes the user's personal playlist along with any modifications to the playlist provided by the remaining plurality of users.

15. The non-transitory computer readable media of claim 13, further comprising the non-transitory computer-readable medium having instruction stored thereon for causing a suitably programmed computer to execute a method comprising generating the group playlist common to all of the plurality of users that includes contributions from each user's personal playlist along with any modifications to the group playlist provided by the remaining plurality of users.
